(19) United States
(12) Patent Application Publication
(10) Pub. No.: US 2026/0154580 A1
(43) Pub. Date: Jun. 4, 2026

(54) ZERO-TRUST MULTI-AGENT GOVERNANCE FRAMEWORK FOR CLINICAL ARTIFICIAL INTELLIGENCE

(71) Applicant: George William Bickerstaff, III, Greenwich, CT (US)

(72) Inventor: George William Bickerstaff, III, Greenwich, CT (US)

(21) Appl. No.: 19/455,879

(22) Filed: Jan. 22, 2026

(51) Int. Cl. G06N 5/04

(52) U.S. Cl. CPC G06N 5/04

(57) ABSTRACT

A zero-trust multi-agent governance framework distributes artificial intelligence oversight across independent evaluators. Inference outputs are evaluated by specialized agents, aggregated by a hardware-isolated governance engine, and released only upon consensus approval. The framework reduces systemic risk while providing deterministic enforcement and regulatory transparency.

### TECHNICAL FIELD

The present invention relates to governance systems for artificial intelligence operating in regulated environments.

More specifically, the invention relates to zero-trust, multi-agent governance architectures that evaluate artificial intelligence inference outputs prior to execution beyond a controlled boundary.

The invention separates inference generation from compliance determination to reduce systemic risk and compounding error.

### BACKGROUND

Artificial intelligence systems deployed in clinical and diagnostic settings increasingly influence high-impact decisions.

Traditional governance approaches rely on single-model validation, centralized rule engines, or monolithic oversight systems.

Such architectures create single points of failure and allow correlated errors to propagate unchecked.

A failure in one validation component may compromise the entire governance layer.

Software-only governance mechanisms are susceptible to bypass, misconfiguration, or insufficient domain specialization.

There exists a need for a governance framework that distributes oversight across independent evaluators.

Such a framework must enforce consensus before permitting execution and must remain isolated from inference logic.

The present invention addresses these deficiencies by providing a zero-trust, multi-agent governance framework.

### SUMMARY OF THE INVENTION

The disclosed invention provides a decentralized governance architecture for clinical artificial intelligence systems.

A plurality of specialized governance agents independently evaluate captured inference outputs against domain-specific validation criteria.

A hardware-isolated governance engine aggregates agent determinations and enforces a consensus decision.

Execution beyond an execution boundary is permitted only upon satisfaction of consensus requirements.

Failure by any required agent results in deterministic blocking or escalation.

All governance decisions are recorded in tamper-resistant audit logs suitable for regulatory review.

### Definitions

Clearance Token means a cryptographically verifiable artifact authorizing execution beyond an execution boundary.

Consensus Decision means an aggregated governance outcome derived from multiple independent agent evaluations.

Execution Boundary means a control point where inference outputs affect downstream systems.

Governance Agent means an independent evaluator configured to assess inference outputs against specific criteria.

Governance Engine means a hardware-isolated controller that enforces consensus logic.

Machine-Readable Compliance Criteria means encoded rules defining regulatory or safety requirements.

Trusted Execution Environment means a hardware-protected isolated execution space.

Violation Signal means a deterministic signal indicating governance failure.

### BRIEF DESCRIPTION OF THE DRAWINGS

FIG. 1 illustrates multi-agent governance architecture.

FIG. 2 illustrates agent evaluation process.

FIG. 3 illustrates consensus determination.

FIG. 4 illustrates execution enforcement.

FIG. 5 illustrates governance logging.

### DETAILED DESCRIPTION OF THE DRAWINGS

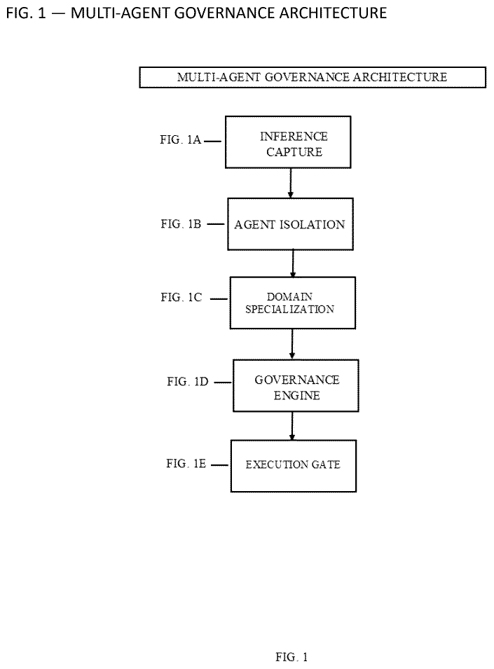

FIG. 1—MULTI-AGENT GOVERNANCE ARCHITECTURE

FIG. 1A—INFERENCE CAPTURE illustrates capture of inference outputs prior to reaching an execution boundary. Outputs are mirrored for governance evaluation. Inference execution is paused.

FIG. 1B—AGENT ISOLATION illustrates isolation of governance agents from inference software. Each agent executes independently. Cross-contamination is prevented.

FIG. 1C—DOMAIN SPECIALIZATION illustrates assignment of agents to specialized validation domains. Domains may include safety, bias, or clinical relevance. Specialization improves accuracy.

FIG. 1D—GOVERNANCE ENGINE illustrates a hardware-isolated governance engine coordinating agent evaluations. The engine aggregates results. Enforcement is deterministic.

FIG. 1E—EXECUTION GATE illustrates an execution gate controlling output release. The gate opens only upon consensus approval. Unauthorized execution is blocked.

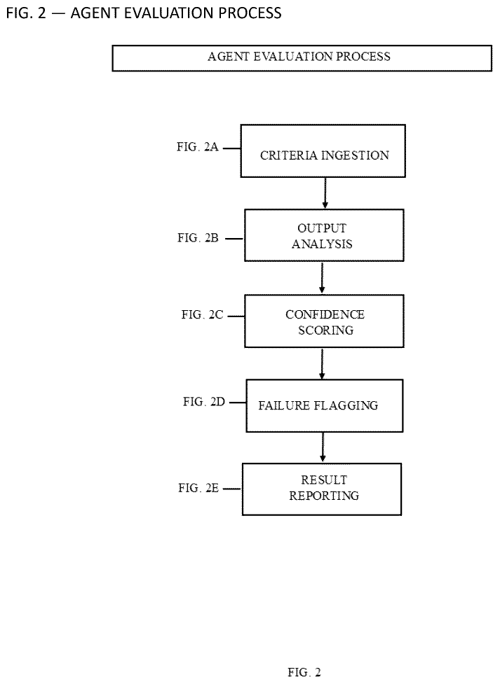

FIG. 2—AGENT EVALUATION PROCESS

FIG. 2A—CRITERIA INGESTION illustrates ingestion of machine-readable compliance criteria by each agent. Criteria are regulator-approved. Unauthorized changes are prevented.

FIG. 2B—OUTPUT ANALYSIS illustrates independent analysis of inference outputs by each agent. Analysis is domain-specific. Agents do not share intermediate state.

FIG. 2C—CONFIDENCE SCORING illustrates generation of confidence scores by agents. Scores reflect compliance certainty. Low scores indicate risk.

FIG. 2D—FAILURE FLAGGING illustrates flagging of non-compliant outputs by individual agents. Flags propagate to the governance engine. Evaluation continues.

FIG. 2E—RESULT REPORTING illustrates reporting of agent determinations to the governance engine. Reports are signed. Integrity is ensured.

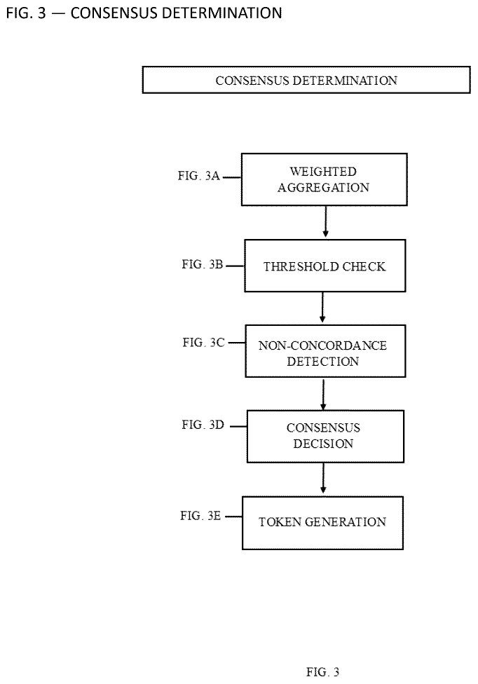

FIG. 3—CONSENSUS DETERMINATION

FIG. 3A—WEIGHTED AGGREGATION illustrates weighted aggregation of agent determinations. Weights may be predefined. Aggregation is deterministic.

FIG. 3B—THRESHOLD CHECK illustrates comparison of aggregated results to consensus thresholds. Thresholds are regulator-defined. Exceedance permits execution.

FIG. 3C—NON-CONCORDANCE DETECTION illustrates detection of conflicting agent outputs. Conflict triggers escalation. Automatic approval is prevented.

FIG. 3D—CONSENSUS DECISION illustrates generation of a final consensus decision. Decisions are binary or multi-state. The outcome governs execution.

FIG. 3E—TOKEN GENERATION illustrates generation of a clearance token upon consensus approval. The token is cryptographically bound. Scope is enforced.

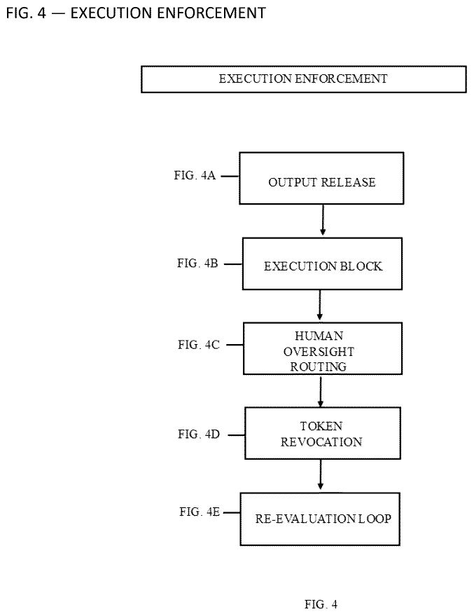

FIG. 4—EXECUTION ENFORCEMENT

FIG. 4A—OUTPUT RELEASE illustrates release of inference outputs upon consensus approval. Outputs pass the execution boundary. Downstream systems receive results.

FIG. 4B—EXECUTION BLOCK illustrates blocking of outputs upon governance failure. No downstream propagation occurs. Safety is preserved.

FIG. 4C—HUMAN OVERSIGHT ROUTING illustrates routing of failed cases for human review. Human-in-the-loop oversight is enabled. Automation pauses.

FIG. 4D—TOKEN REVOCATION illustrates revocation of clearance tokens upon detected violations. Revocation is immediate. Execution halts.

FIG. 4E—RE-EVALUATION LOOP illustrates re-evaluation following remediation or updated criteria. Governance restarts cleanly. State contamination is avoided.

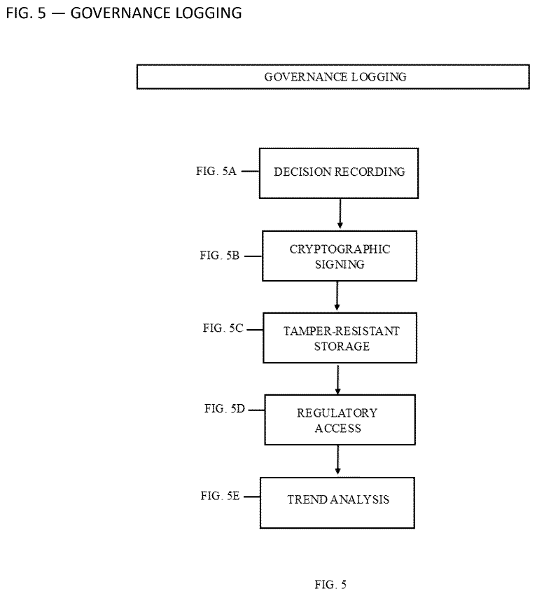

FIG. 5—GOVERNANCE LOGGING

FIG. 5A—DECISION RECORDING illustrates recording of all agent determinations. Records include timestamps and domains. Completeness is ensured.

FIG. 5B—CRYPTOGRAPHIC SIGNING illustrates signing of governance records. Signing prevents repudiation. Integrity is enforced.

FIG. 5C—TAMPER-RESISTANT STORAGE illustrates storage of governance logs in protected systems. Logs are append-only. Alteration is prevented.

FIG. 5D—REGULATORY ACCESS illustrates retrieval of governance logs for regulatory inspection. Access is read-only. Transparency is preserved.

FIG. 5E—TREND ANALYSIS illustrates analysis of governance outcomes over time. Trends inform policy updates. System resilience improves.

### Examples

In one example, a clinical inference is evaluated by safety, bias, and clinical relevance agents. One agent flags non-concordance. Execution is blocked and routed for review.

In another example, all agents approve an inference within defined thresholds. A clearance token is issued. Execution proceeds automatically.

1. A system for governing execution of artificial intelligence in a regulated environment, comprising:
a plurality of independent governance agents configured to evaluate inference outputs against machine-readable compliance criteria;
a hardware-isolated governance engine configured to aggregate agent determinations; and
control logic configured to permit execution beyond an execution boundary only upon satisfaction of a consensus decision.

2. A computer-implemented method comprising:
capturing inference outputs prior to execution;
independently evaluating the outputs using multiple specialized governance agents; and
blocking execution when consensus approval is not achieved.

3. A governance controller operating within a trusted execution environment, configured to generate a cryptographically verifiable clearance token only when a plurality of independent agents approve execution.

4. The system of claim 1, wherein failure of any required agent generates a violation signal.

5. The method of claim 2, wherein non-concordant agent outputs trigger human-in-the-loop escalation.

6. The governance controller of claim 3, wherein agent determinations are weighted by domain relevance.

7. The system of claim 1, wherein governance agents are isolated from inference software.

8. The method of claim 2, wherein governance decisions are recorded in an immutable audit log.

9. The governance controller of claim 3, wherein clearance tokens are scoped to specific execution contexts.

10. The system of claim 1, wherein modification of compliance criteria invalidates prior clearance tokens.
